(19) United States
(12) Patent Application Publication
(10) Pub. No.: US 2025/0088441 A1
(43) Pub. Date: Mar. 13, 2025

(54) SYSTEM AND METHOD FOR AUTOMATED CONFIGURATION OF CLOUD DEVICE MANAGEMENT SERVICES

(71) Applicant: Toshiba TEC Kabushiki Kaisha, Shinagawa-ku (JP)

(72) Inventors: Milong SABANDITH, Irvine, CA (US); Gouse Basha SHAIK, Lake Forest, CA (US)

(21) Appl. No.: 18/367,822

(22) Filed: Sep. 13, 2023

(51) Int. Cl. H04L 43/065; H04L 43/106; H04L 43/50

(52) U.S. Cl. CPC H04L 43/065; H04L 43/106; H04L 43/50

(57) ABSTRACT

A system and method for automated seeding a cloud device management service for monitoring devices in different locations includes a designated gathering device placed on a network of each of the locations. A gathering device discovers information about its network via DHCP and then scans its network to find active devices and their associated addresses. An SNMP query using a community string determines which devices are scannable for SNMP queries. The gathering device then tests its network and generates a resulting timeout value. The network information, device information, scannable device list and timeout value are sent to the cloud device management system to seed it with information for managing devices at each location.

### TECHNICAL FIELD OF THE INVENTION

This application relates generally to cloud managed printing systems. The application relates more particularly to automatedly supplying network and device information to a cloud service for a local network to configure the cloud service for management of devices in the local network.

### BACKGROUND OF THE INVENTION

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

Fleets of MFPs may be managed by a cloud service. A cloud-based MFP management system operates by hosting its services on remote cloud servers, eliminating a need for on-site infrastructure. Administrators enroll their MFPs and copiers with the cloud platform, configuring them to communicate with it. Once enrolled, the system continuously monitors these devices, collecting data such as status, usage statistics, and supply levels. It also manages firmware and software updates, automating the process to ensure devices are up to date. Administrators can remotely configure device settings, enforce policies, and receive alerts for various events like offline devices or low supplies. Usage analytics provide insights into device utilization, while security features protect data transmission and access. Cost management tools help monitor printing expenses, and some systems offer user self-service portals. Additionally, cloud-based MFP management systems are scalable and often support integration with other business applications, providing flexibility and efficiency in device management.

### BRIEF DESCRIPTION OF THE DRAWINGS

Various embodiments will become better understood with regard to the following description, appended claims and accompanying drawings wherein:

FIG. 1 is an example embodiment of a system for automated configuration of cloud-based device management services;

FIG. 2 is an example embodiment of a networked digital device, such as a multifunction peripheral;

FIG. 3 is an example embodiment of a digital device system;

FIG. 4 is a block diagram of an example embodiment of a system for automated configuration of cloud-based device management services;

FIG. 5 is an example embodiment of a system for automated configuration of cloud-based device management services; and

FIG. 6 is an example embodiment of a data collection user interface.

### DETAILED DESCRIPTION OF THE INVENTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

Remote cloud services can make use of SNMP (Simple Network Management Protocol) for a range of purposes in managing networked devices and infrastructure. SNMP facilitates the monitoring of MFPs, as well as devices such as routers, switches, servers, and storage systems. By querying these devices, cloud services can gather critical performance data like CPU utilization, memory usage, and system uptime. SNMP traps enable real-time alerts and notifications, allowing cloud services to respond promptly to events such as high CPU usage or hardware faults. SNMP also supports remote configuration, making it possible for cloud services to adjust device settings as needed. Additionally, SNMP is employed for firmware and software updates, ensuring devices remain secure and up-to-date. SNMP data aids in resource optimization, helping identify underutilized devices and network bottlenecks. It plays a role in security monitoring by tracking security-related events and compliance, such as failed login attempts. The protocol's scalability makes it suitable for large-scale infrastructures, and it can be integrated with other management and monitoring tools, enhancing the overall network management capabilities of cloud services.

MFP information that may be obtainable with SNMP include:
Device Information: Manufacturer, model, firmware version, and serial number.
Status Information: Operational status (e.g., online, offline, busy), error conditions, and paper/toner levels.
Configuration Settings: Network settings, printer settings, and security configurations.
Counters and Metrics: Page counters, copy/scan/fax counters, and consumables usage.
Tray and Input/Output Details: Information about paper trays, finishers, and output bins.
Job Queue Information: Print job details, such as job name, status, and owner.
Security Auditing: Logs of device activities and access attempts.
Device Capabilities: Supported protocols, print languages, scan formats, and features.
Device Alerts: SNMP traps for events like paper jams or low toner.
Environmental Data: Temperature and humidity (if available).
Device Location: Physical placement within the network.
Power Management: Power status and usage metrics (if supported).

This client process can perform a simple SNMP test to determine if some devices are currently scannable using default community string. An SNMP community string is a means of accessing statistics stored within a router or other device. Sometimes referred to simply as a community string or an SNMP string, a device will usually feature a default SNMP community string, which is dependent on the vendor responsible for the device. Some vendors use the word “public” as the default.

Current SNMP-based cloud management systems must be manually pre-configured with various IP address/Subnet Mask ranges for monitored devices. With large numbers of devices, devices for different customers, as well as customers having devices at different locations, loading, confirming and maintaining this information can be tedious and time consuming. Additionally, customer network information or configurations can change, leading to errors or omissions in device monitoring.

Example embodiments herein provide automated, on-site network and device analysis by use of a computer system deployed on-site at a customer's premises and in their local network. The system employs SNMP and Dynamic Host Configuration Protocol (DHCP) to acquire device, configuration and network information locally and relay them to a cloud management system to automatically configure its own SNMP data collection system.

Example embodiments herein further determine network properties, such as network timeout settings, and report them to the cloud service. A network timeout setting is a configuration parameter that sets a maximum allowable time for a network operation to complete before it is considered unsuccessful or “times out.” It places a limit on how long an application or device should wait for a response or an action to take place within a network transaction. Network timeouts are categorized into various types, including connection timeouts (for establishing connections), read timeouts (for waiting on data from the server), write timeouts (for data transmission), and overall request timeouts that encompass the entire request-response cycle. These settings can be adjustable, tuning network environments. Properly configuring timeout values is vital for ensuring responsive and reliable networked applications, as excessively short timeouts can lead to premature failures, while overly long timeouts can hinder application performance and resource efficiency.

In example embodiments herein, network timeouts are suitably determined network monitoring by periodically sending Internet Control Message Protocol (ICMP) echo requests (ping) to local devices. Response times are suitably analyzed and recorded to gather latency data over time. This data is then subjected to statistical analysis to identify patterns and trends. Thresholds are established based on this analysis, defining acceptable network performance. The device suitably calculates dynamic timeouts when average latency exceeds predefined thresholds, adapting to network conditions. Subsequently, it securely relays this latency and timeout data to the cloud service using a secure channel or application program interface (API). The cloud service aggregates and analyzes this information, triggering alerts or management actions if network performance issues are detected. This approach maintains an adaptive feedback loop, ensuring that timeout values remain accurate and responsive to changing network conditions.

Device scan-ability is suitably determined via an SNMP query by the local device. A suitable query is to retrieve system information like sysName or sysDescr. If the query is successful, it means that a device's SNMP community string is valid, and a management system can have SNMP access to the device.

In example embodiments herein, additional information is obtained via DHCP. This information may include assignment of an IP addresses, a subnet mask, and a default gateway's IP address, which is the route to external networks and the internet. DHCP also conveys DNS server information, enabling the translation of domain names to IP addresses. DHCP can also be used to automate a process of configuring devices on IP networks, thus allowing them to use network services such as DNS, NTP, and any communication protocol based on UDP or TCP. Furthermore, DHCP may provide the domain name of the local network, hostname, time server details for clock synchronization, and lease information specifying IP address duration. Other potential offerings from DHCP include router configuration options, vendor-specific settings, and static IP mapping for specific devices based on their MAC addresses.

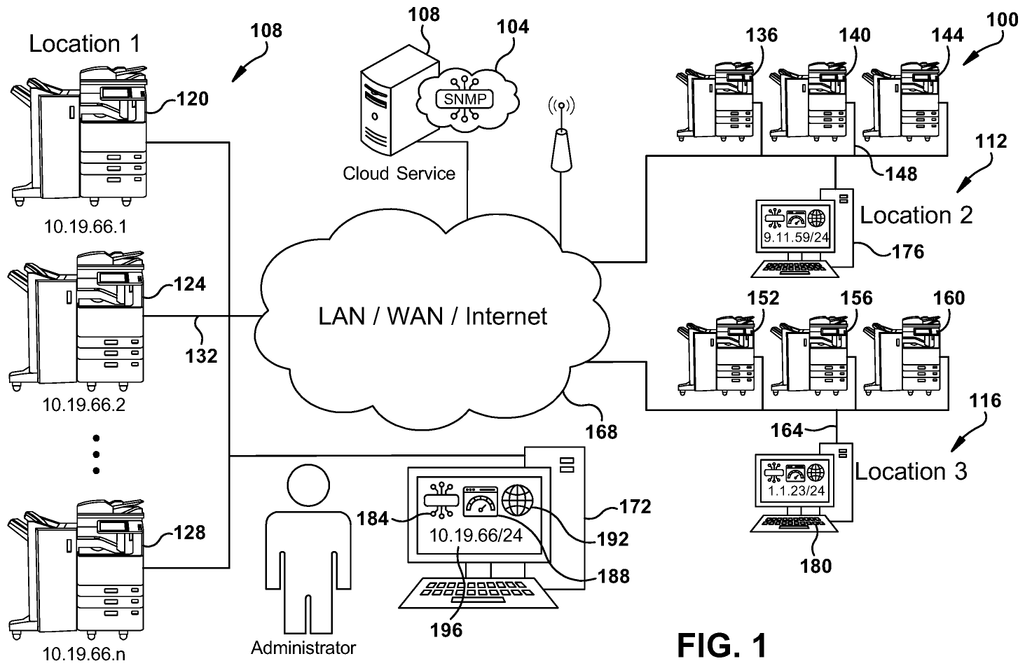

FIG. 1 illustrates a system 100 for automated configuration of cloud-based device management services. Cloud service 104 includes one or more servers, such as server 108. Most MFP manufacturers employ cloud services to manage their devices, such as Toshiba's e-BRIDGE CloudConnect (ECC) system, Xerox ConnectKey and Ricoh Smart Integration. Example embodiments herein include ECC, but it is to be understood that any suitable cloud management service and be used. Cloud service 104 manages multiple MFPs at multiple locations, such as location 1 108, location 2 112 and location 3 116. Location 1 includes MFPs 120, 124 and 128 connected via local area network (LAN) 132. Location 2 includes MFPs 136, 140 and 144 connected via LAN 148. Location 3 includes MFPs 152, 156 and 160 connected via LAN 164.

Devices in FIG. 1 are in data communication via network cloud 168, suitably comprised of LANs, a wide area network (WAN), which may comprise the Internet, or any suitable combination thereof. Network cloud 168 is comprised of any suitable wireless or wired data connection or combination thereof and provides for data transfer between devices such as those illustrated in FIG. 1. While workstations appear in the example embodiment of FIG. 1, it is to be appreciated that any suitable data processing system can be used, including an MFP itself insofar as it includes, noted below, an intelligent controller that can function as a general purpose computing device. Workstation 172 includes functionality for SNMP service, network monitoring 188 and DHCP service 192.

Each LAN is provided with an administrative terminal, such as workstation 172 of Location 1, workstation 176 of Location 2, and workstation 180 of Location 3. Using Location 1 as a detailed example, each MFP includes an IP address in LAN 132 having a subnet 196 of 10.19.66/24.

The notation “10.19.66/24” in Classless Inter-Domain Routing (CIDR) format represents an IPV4 subnet with a fixed network address of “10.19.66” and a variable host portion. The “/24” indicates that the first 24 bits are used for network identification, allowing for 256 possible host addresses (ranging from 10.19.66.0 to 10.19.66.255). This notation is commonly used in networking to define IP address ranges within a specific network, where the last octet can vary for individual host assignments while sharing the same network prefix.

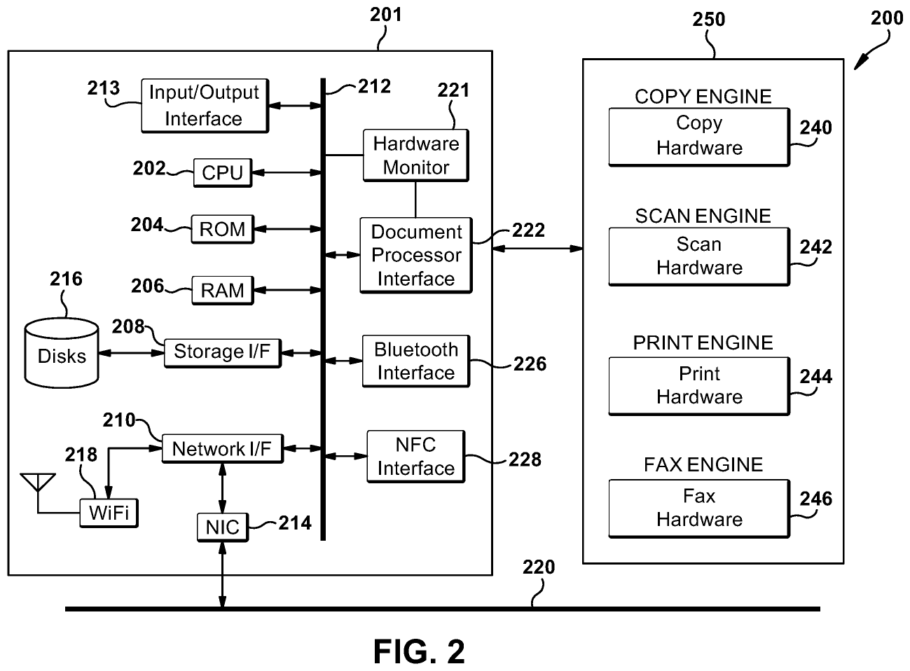

Turning now to FIG. 2, illustrated is an example embodiment of a networked digital device comprised of document rendering system 200 suitably comprised within an MFP, such as with the MFPs of FIG. 1. It will be appreciated that an MFP includes an intelligent controller 201 which is itself a computer system. Thus, an MFP can itself function as a server with the capabilities described herein. Included in intelligent controller 201 are one or more processors, such as that illustrated by processor (CPU) 202. Each processor is suitably associated with non-volatile memory, such as read-only memory (ROM) 204, and random access memory (RAM) 206, via a data bus 212.

Processor 202 is also in data communication with input/output interface 213, suitably comprising a user touchscreen. While touchscreens are discussed in example embodiments herein, it is to be appreciated that any suitable user interface, such as keyboards, switches, displays, trackballs or mice may be used.

Processor 202 is also in data communication with a storage interface 208 for reading or writing to a storage 216, suitably comprised of a hard disk, optical disk, solid-state disk, cloud-based storage, or any other suitable data storage as will be appreciated by one of ordinary skill in the art.

Processor 202 is also in data communication with additional interfaces, such as Bluetooth interface 226 and NFC interface 228.

Processor 202 is also in data communication with a network interface 210 which provides an interface to a network interface controller (NIC) 214, which in turn provides a data path to any suitable wired interface or physical network connection 220, or to a wireless data connection via wireless network interface 218. Example wireless network interfaces include optical, cellular, Wi-Fi, wireless universal serial bus (wireless USB), satellite, and the like. Example wired interfaces include Ethernet, USB, IEEE 1394 (FireWire), Lightning, telephone line, or the like.

Processor 202 can also be in data communication with any suitable user input/output (I/O) which provides data communication for interfacing with user peripherals, such as displays, keyboards, mice, track balls, touch screens, or the like. Processor 202 can also be in communication with hardware monitor 221, such as a page counter, temperature sensor, toner or ink level sensor, paper level sensor, or the like.

Also in data communication with data bus 212 is a document processor interface 222 suitable for data communication with the document rendering system 250, including MFP functional units. In the illustrated example, these units include a copy engine comprising copy hardware 240, a scan engine comprise of scan hardware 242, a print engine comprised of print hardware 244 and a fax engine comprised of fax hardware 246 which together comprise document rendering system 250. It will be understood that functional units are suitably comprised of intelligent units, including any suitable hardware or software platform.

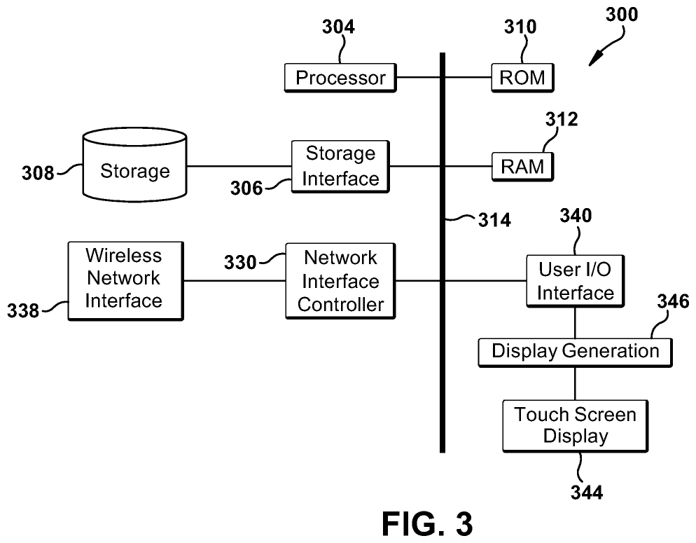

Turning now to FIG. 3, illustrated is an example embodiment of a digital data processing device 300 such as cloud server 108 and workstations 172, 176 and 180 of FIG. 1. It is to be appreciated that some components listed may be unnecessary in certain configurations. Components of the digital data processing device 300 suitably include one or more processors, illustrated by processor 304, memory, suitably comprised of read-only memory 310 and random access memory 312, and bulk or other non-volatile storage 308, suitably connected via a storage interface 306. Data communication among components is accomplished via data bus 314. A network interface controller 330 suitably provides a gateway for data communication with other devices, via any wireless or wired connection, such as via wireless network interface 338. A user input/output interface 340 is suitably comprised of display generator 346 interfacing with touchscreen display 344. As noted above, any suitable user input and display can be used. User input/output interface 340 also provides connection to biometric sensor 348, suitably comprised of a fingerprint sensor, retinal sensor, or the like, and may be used to secure device access to one or more users.

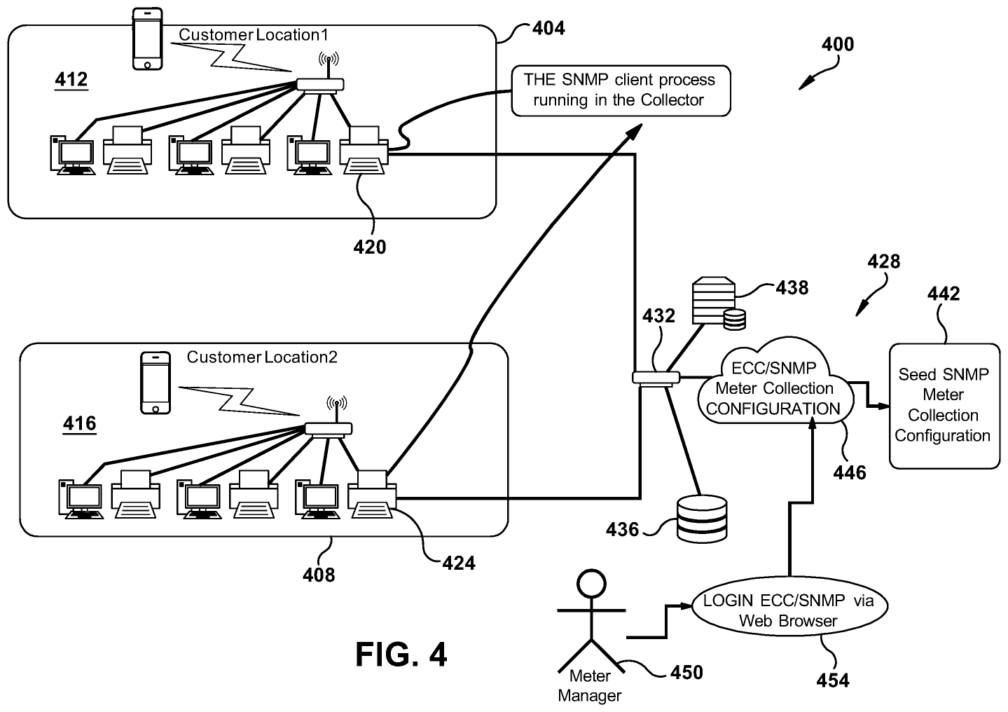

FIG. 4 illustrates a block diagram 400 of an example embodiment of a system for automated configuration of cloud-based device management services. Included are first customer location 404 and second customer location 408. Location 404 includes multiple network devices 412 and location 408 includes multiple network devices 416. A SNMP client as detailed above is provided by data collector device 420 in location 404 and by data collector device 424 in location 408.

In an MFP network, an SNMP data collector is a system or software component that gathers data from SNMP-enabled devices. It communicates with these devices through SNMP queries to collect information such as device status, page counts, toner levels, and configuration settings. The data collector stores this information centrally, allowing for historical analysis and alerting administrators of issues like low toner levels. It often integrates with network management tools and can trigger automated actions based on predefined conditions, enhancing the monitoring and management of MFP devices in the network while maintaining security through protocols like SNMPv3. Both location 404 and location 408 are in network data communication with cloud management service 428. Cloud management service 428 includes cloud server 432, cloud storage 436 and cloud operations unit 438. Seed SNMP meter collection information configuration information 442 is received from SNMP client data collector devices 420 and 424 and serves to configure meter collection configuration 446. Manual configuration changes or additions can be accomplished by meter manager user 450 who logs into the system via web browser 454.

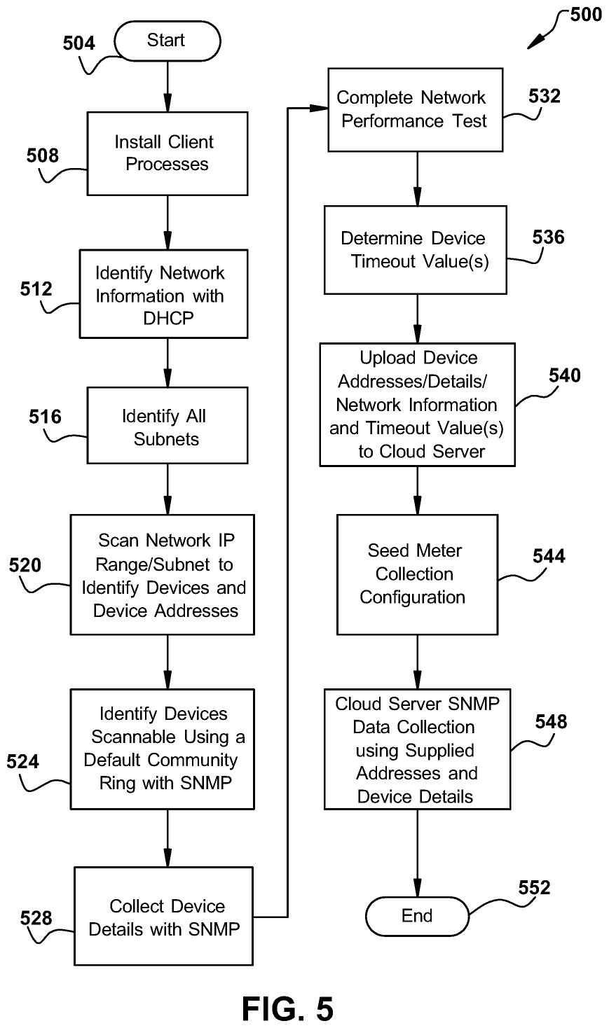

FIG. 5 illustrates a flowchart 500 of an example embodiment of a system for automated configuration of cloud-based device management services. The process commences at block 504 and proceeds to block 508 wherein client processes for data collection detailed above are installed and enabled. Network information is then obtained at block 512 via DHCP. All subnets are then identified at block 516. A scan is made at block 520 to a network IP range or subnet to identify devices. Identified devices are tested at block 524 to determine those that are scannable. SNMP device details are scanned at block 528 from scannable devices. A network performance test is completed at block 532 and one or more device timeout values determined at block 536. Device details, addresses, network information and timeout information is sent to a cloud service server at block 540 and it is used to seed cloud servicing configuration at block 544. Data is collected at the cloud server SNMP using supplied addresses and device details at 548. The process then ends at block 552.

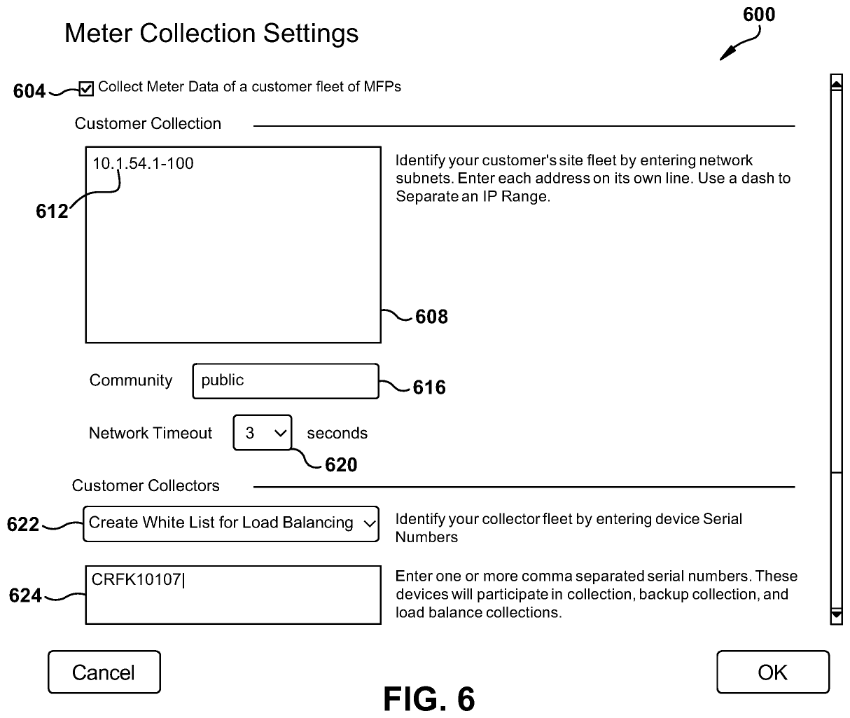

FIG. 6 illustrates an example embodiment of a data collection user interface 600. Meter collection is enabled by checking bock 604. Customer collection information is provided in block 608, which contains CIDR subnet 612. A community string value for SNMP collection is entered at window 616 and a network timeout value is set at block 620. Collector devices are specified in window 622, suitably by device serial number entered into block 624.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

It is claimed:

1. A system comprising:
a processor and associated memory; and
a network interface configured for data communication with an associated network;
the processor configured to
identify a subnet associated with the associated network,
determine network properties of the associated network,
identify active devices in the subnet,
submit an initial SNMP query test to each active device,
determine which active devices are scannable in accordance with responses received from SNMP querying,
identify an address for each scannable device,
generate a report of identified network properties, scannable devices and addresses of scannable devices, and
send the generated report to a device cloud management system via the network interface.

2. The system of claim 1 wherein the processor is further configured to determine the network properties including a timeout value associated with the associated network and send the timeout value to the device cloud management system with the report.

3. The system of claim 2 wherein the processor is further configured to determine at least a portion of the network properties via DHCP.

4. The system of claim 3 wherein initial SNMP query is comprised of a device community string query.

5. The system of claim 3 wherein the network properties determined via DHCP include one or more of IP addresses, leased IP addresses, MAC addresses, lease expiration times, client hostnames, DNS server addresses, default gateways, server logs, IP address exclusions, scope information, server status, and event or error reporting.

6. The system of claim 5 wherein the processor is further configure to determine the timeout value in accordance with time values associated with one or more ICMP echo.

7. The system of claim 5 wherein identification of the subnet includes identification of a IP address range of the subnet.

8. A method comprising:
identifying a subnet associated with a network;
determining network properties of the network;
identifying active devices in the subnet;
submitting an initial SNMP query test to each active device;
determining which active devices are scannable in accordance with responses received from SNMP querying;
identifying an address for each scannable device;
generating a report of identified network properties, scannable devices and addresses of scannable devices; and
sending the generated report to a device cloud management system via a network interface.

9. The method of claim 8 further comprising determining the network properties including a timeout value associated with the network and send the timeout value to the device cloud management system with the report.

10. The method of claim 9 further comprising determining at least a portion of the network properties via DHCP.

11. The method of claim 10 wherein initial SNMP query is comprised of a device community string query.

12. The method of claim 11 wherein the network properties determined via DHCP include one or more of IP addresses, leased IP addresses, MAC addresses, lease expiration times, client hostnames, DNS server addresses, default gateways, server logs, IP address exclusions, scope information, server status, and event or error reporting.

13. The method of claim 12 further comprising determining the timeout value in accordance with time values associated with one or more ICMP echo.

14. The method of claim 13 wherein the identification of the subnet includes identification of an IP address range of the subnet.

15. A non-transitory computer readable storage medium storing a program for causing a digital data device to execute a control method, the control method comprising:
identifying a subnet associated with a network;
determining network properties of the network;
identifying active devices in the subnet;
submitting an initial SNMP query test to each active device;
determining which active devices are scannable in accordance with responses received from SNMP querying;
identifying an address for each scannable device;
generating a report of identified network properties, scannable devices and addresses of scannable devices; and
sending the generated report to a device cloud management system via a network interface.

16. The non-transitory computer readable storage medium of claim 15 wherein the control method further comprises determining the network properties including a timeout value associated with the network and send the timeout value to the device cloud management system with the report.

17. The non-transitory computer readable storage medium of claim 16 wherein the control method further comprises determining at least a portion of the network properties via DHCP.

18. The non-transitory computer readable storage medium of claim 17 wherein the initial SNMP query is comprised of a device community string query.

19. The non-transitory computer readable storage medium of claim 18 wherein the network properties determined via DHCP include one or more of IP addresses, leased IP addresses, MAC addresses, lease expiration times, client hostnames, DNS server addresses, default gateways, server logs, IP address exclusions, scope information, server status, and event or error reporting.

20. The non-transitory computer readable storage medium of claim 19 wherein the control method further comprises comprising determining the timeout value in accordance with time values associated with one or more ICMP echo.
